(19) United States
(12) Patent Application Publication
(10) Pub. No.: US 2014/0379777 A1
(43) Pub. Date: Dec. 25, 2014

(54) DEVICE AND METHOD FOR PERFORMING DISTRIBUTED PROCESSING

(71) Applicant: FUJITSU LIMITED, Kawasaki-shi (JP)

(72) Inventors: Tetsu Yamamoto, Kawasaki (JP); Kazuya KAWASHIMA, FUKUOKA (JP); Tadashige IWAO, Beijing (CN)

(21) Appl. No.: 14/482,315

(22) Filed: Sep. 10, 2014

Related U.S. Application Data
(63) Continuation of application No. PCT/JP2012/058551, filed on Mar. 30, 2012.

(51) Int. Cl. H04L 29/08; H04W 56/00

(52) U.S. Cl. CPC H04L 67/1095; H04W 56/001; H04W 84/18
USPC 709/201

(57) ABSTRACT

A computer-readable recording medium has stored therein a program for causing a computer to execute a process including storing, as a variable set, a database of a variable that associates a key, a value and a synchronization destination corresponding to the key, executing a process of requesting that the variable in the variable set of the computer be referred to or updated in a state and evaluating a condition so as to make the state transition to a different state, and communicating the key specified by the request with the synchronization destination for the variable corresponding to the key specified by the request and synchronizing the value of the variable corresponding to the key in the computer and the value of the variable corresponding to the key in the variable set of the synchronization destination when the process of requesting is executed.

### CROSS-REFERENCE TO RELATED APPLICATION

This application is a continuation application of International Application PCT/JP2012/058551 filed on Mar. 30, 2012, and designated the U.S., the entire contents of which are incorporated herein by reference.

### FIELD

The embodiments discussed herein are related to a device and a method that perform distributed processing in a sensor network including distributed sensor nodes.

### BACKGROUND

Sensor networks, represented by ad-hoc networks, are for example a multi-hop wireless network that distributes nodes, which are a plurality of wireless terminals having a sensor, in space so that the distributed nodes perform communications in a coordinated manner in order to collect pieces of information about the environment and physical states.

A node is a built-in device whose performance is limited in comparison with hardware such as a high-performance server system. A CPU of a center server for example operates at 64 bits/3.0 gigahertz clock, whereas the CPU of a node operates at 8 bits/8 megahertz clock. A RAM (Random Access Memory) of a center server for example has the storage capacity of several tens of gigabytes, whereas the RAM of a node has the storage capacity of several tens of kilo bytes. A center server does not have for example a ROM (Read Only Memory), whereas a node has a ROM of several tens of kilobytes. The communication specification of a center server for example is 1 gigabits/second for wired communications, whereas the communication specification of anode is several tens through several hundreds of kilo bits/second for wireless communications.

A representative traffic model is Multipoint to Point (M2P) communication, in which sensor data of several bytes obtained by many (in the order of ten thousand) nodes is transmitted to a server. Communications between respective nodes in a sensor network and a server in an external network (the Internet etc.) are relayed by a gateway arranged in the sensor network. Accordingly, communications between respective nodes and the gateway also adopt M2P communication. Point to Point (P2P) communications between nodes have lighter traffic than M2P traffic between nodes and a gateway.

As a data processing model in a sensor network having the above characteristics, a method is widely employed in which pieces of data are collected in a lump from nodes to a server via a gateway so as to return a result obtained by analyzing the data to a control device in P2P. Pieces of data are periodically collected to the gateway and the server at one time and the server analyzes the information and gives an instruction via P2P to a particular sensor node in accordance with the analysis result.

However, in a large-scale sensor network having many nodes in the order of ten thousand or more, a large amount of data causes elongated processing time and network congestion. Accordingly, it is desirable that distributed processing be performed.

When distributed processing is to be performed in a sensor network, it is preferable to take into consideration a sensor node having low processing performance and low-cost communications between nodes.

Wireless sensor networks vary in configurations dynamically in accordance with movements of nodes and radio wave conditions in wireless communications. When pieces of a large amount of data are collected in a data center in a lump, it is difficult to predict where the traffic will concentrate. Accordingly, congestion occurred around a gateway eventually.

Regarding this problem, a conventional technique has been known in which a plurality of GWs are arranged on the boundary between an ad-hoc network and the center server.

This technique aims to distribute traffic to nodes so as to avoid congestion by recording GWs with high efficiency and transmitting frames via such GWs when the center server transmits frames to nodes.

However, according to this conventional technique, the effect of the avoidance of congestion around a GW is expected, whereas the number of frames that reach a server does not change, and accordingly the technique is a processing model of the center-concentrated type.

Also, a conventional technique has been known that includes a plurality of managed computers that bring about various events asynchronously and a managing computer, which manages schedules of the plurality of managed computers and such events. The managing computer includes an integrated management unit that manages events in an integrated manner and makes the process proceed to the next process in accordance with the result of the management by the integrated management unit.

However, also this conventional technique makes the managing computer perform integrated management of events and work flows, and accordingly is a processing model of a center-concentrated type.

As described above, processing models of a center-concentrated type have usually been employed, resulting in the problem that data processing takes a long period of time and swift response is not possible. When, for example, ten million pieces of data are collected and processed, it takes 100 ms×ten million pieces=one million seconds (nearly 12 days) in a case where the processing period of time for one piece of data is assumed to be 100 ms (milliseconds). When a sensor network is applied for an application in which the abnormal process is executed at the same time a sensor detects an intruder such as in a case of an alert device of a building management system, the application has conventionally been limited to small-scale networks, having several hundreds of nodes.

As described above, in the data processing in a sensor network, the center-concentrated model collects and analyzes pieces of data from nodes to the server and returns the result to the nodes. However, in large-scale networks, there has been a problem that traffic congestion and increased data analysis time make it difficult to make swift responses.

Patent Document 1: Japanese Laid-open Patent Publication No. 2011-199625

Patent Document 2: Japanese Laid-open Patent Publication No. 2001-331468

### SUMMARY

According to an aspect of the embodiments, provided is a computer-readable recording medium having stored therein a program for causing a computer that executes distributed processing in a sensor network to execute a process including storing, as a variable set, a database of a variable that associates a key, a value and a synchronization destination corresponding to the key, executing a process of requesting that the variable in the variable set of the computer be referred to or updated in a state and evaluating a condition while referring to the variable in the variable set of the computer so as to make the state transition to a different state, and communicating the key specified by the request with the synchronization destination for the variable corresponding to the key specified by the request and synchronizing the value of the variable corresponding to the key specified by the request in the variable set in the computer and the value of the variable corresponding to the key specified by the request in the variable set of the synchronization destination when the process of requesting that the variable in the variable set of the computer be referred to or updated is executed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of anode according to an embodiment of the present invention;

FIGS. 2A and 2B illustrate examples of a data structure and a data configuration of a variable set;

FIG. 3 illustrates a data structure of a CB (context box);

FIGS. 4A and 4B are an operation explanation view illustrating a relationship between a state transition process based on the execution, by an SFE, of each CB in a CS and a synchronization process, executed by variable synchronization, of respective variables in respective variable sets between nodes;

FIG. 5 illustrates an example in which the present embodiment is applied to a home security system;

FIGS. 6A and 6B explain a conventional technique;

FIG. 7 illustrates an example of state transition of a CB and an example of updating of a variable set in a home server in an example in which the present embodiment is applied to a home security system;

FIGS. 8A and 8B illustrate an example of state transition of a CB and an example of updating a variable set in a case where sensor nodes, a home server and a center perform distributed processing in an example in which the present embodiment is applied to a home security system;

FIG. 9 is a flowchart illustrating a control operation of an SFE;

FIG. 10 is a flowchart explaining a variable update process (first) in a control operation of variable synchronization;

FIG. 11 is a flowchart explaining a variable update process (second) in a control operation of variable synchronization;

FIG. 12 is a flowchart explaining variable reference process in a control operation of variable synchronization;

FIG. 13 illustrates a configuration of a hardware system that is capable of implementing a system of the present embodiment.

### DESCRIPTION OF EMBODIMENTS

Hereinafter, detailed explanations will be given for the embodiments of the present invention by referring to the drawings.

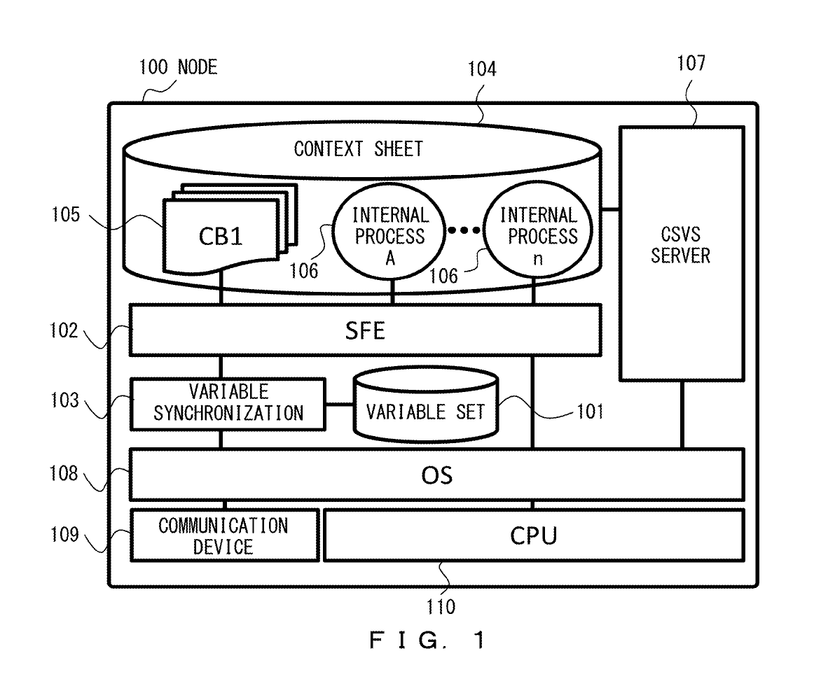

FIG. 1 illustrates a configuration example of a node 100 according to an embodiment of the present invention. The present embodiment may be implemented as a distributed processing device that performs distributed processing in a sensor network including, as a constituent, the node 100 having a sensor. The distributed processing device is for example a node, a gateway or a server. FIG. 1 illustrates a configuration example of a node, however, a gateway or a server may be equipped with the same function. Relationships between a node, a gateway and a server will be explained later in detail.

In FIG. 1, a variable set (VS) (variable set storage unit) 101 stores, as a database, a variable that associates a key (referred to as a “Key” hereinafter) and a value (referred to as a “Value” hereinafter) or a Key and a synchronization destination corresponding to the Key.

A state flow engine (referred to as an “SFE” hereinafter) (state flow engine unit) 102 performs a process including a process of requesting that a variable in a variable set 101 of a node 100 of the SFE be referred to or be updated in one state. Also, an SFE 102 evaluates a condition while referring to a variable in the variable set 101 in the node 100 of the SFE 102 and transitions to a different state. The specific state transition process of the SFE 102 is performed by using a context sheet 104.

The context sheet (referred to as a “CS” hereinafter) 104 is a file that describes a state transition machine by combining context boxes (referred to as “CBs” hereinafter) 105 including a condition portion in which a condition is described or a process portion in which a process to be executed is described. The SFE 102 sequentially reads the CBs 105 described in the CS 104. Also, the SFE 102 is equipped with the function of interpreting the process portion of the read CBs 105 and performing a process of requesting that a variable in the variable set 101 of the node 100 of the SFE 102 be referred to or updated. The SFE 102 evaluates the condition portion of the read CBs 105 while referring to a variable in the variable set 101 of the node 100 of the SFE 102, further evaluates the condition portion in accordance with the result of the evaluation or transitions to the reading of other CBs 105.

Note that internal processes 106 (A through n) illustrated in FIG. 1 represent execution images of a program executed when the SFE 102 makes the respective CBs 105 transition to different states.

Variable synchronization (variable synchronization unit) 103 performs the following processes when the SFE 102 performed the process of requesting that a variable in the variable set 101 of the node 100 of the variable synchronization 103 be referred to or updated. The variable synchronization 103 usually searches the variable set 101 for a variable corresponding to the Key indicated by the request and refers to or updates a Value corresponding to the Key that was searched for. When a synchronization destination has been specified for the variable searched for in the variable set 101 as a variable corresponding to a Key specified by the update request, the variable synchronization 103 communicates the Key specified by the request with the synchronization destination. Then, the variable synchronization 103 synchronizes the Value of the variable corresponding to the Key specified by the request in the variable set 101 of the node 100 of the variable synchronization 103 with the Value of the variable corresponding to the Key specified by the request in the variable set 101 of the synchronization destination. More specifically, the variable synchronization 103 updates the Value of the variable corresponding to the Key in the variable set 101 of the node 100 of the variable synchronization 103 and further transmits, to the synchronization destination, a request message requesting that the variable set 101 specified by the synchronization destination be updated. Also, when the variable synchronization 103 has received an update request message from the synchronization destination, the variable synchronization 103 updates the Value of the variable for the Key in the variable set 101 of the node 100 of the variable synchronization 103. Each variable synchronization 103 of the nodes 100 as the synchronization source and the synchronization destination may communicate a request message (Key specified by the request) and a response message by for example unicast.

A CSVS (Context Sheet Variable Set) server 107 is a program that arranges the CS 104 in a path readable from the SFE 102 via a communication device 109.

An Operating System (OS) 108 provides fundamental functions for executing program functions on a CPU 110 such as the SFE 102, the variable synchronization 103, the CSVS server 107, etc. of the node 100. The CPU 110 is hardware of the central arithmetic processing unit that operates the node 100. The communication device 109 is hardware implementing the wireless communication function with other nodes 100.

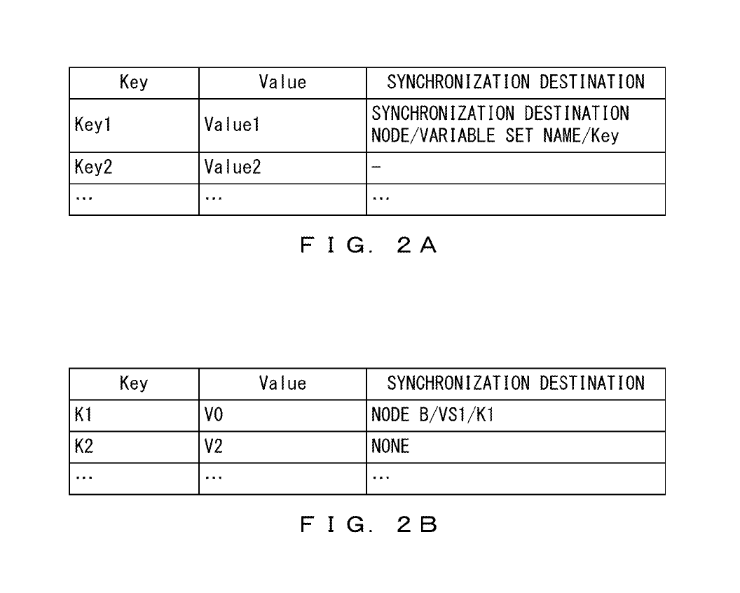

FIGS. 2 illustrate examples a data structure and a data configuration of the variable set 101 illustrated in FIG. 1. As illustrated in the data structure in FIG. 2A, the variable set 101 may store Values such as Value1, Value2, etc. for each Key such as Key1, Key2, etc. Also, the variable set 101 may store synchronization destination for each Key. As a synchronization destination, for example “node name/variable set name/Key” of the synchronization destination may be expressed in the form of an URI. One or both of Value and synchronization destination is registered for one Key. A pair of a Key and a Value or a synchronization destination represents one variable.

FIG. 2B illustrates a data configuration example of the variable set 101. Value=V0, synchronization destination=node 100=node B/variable set 101=VS1/Key=K1 is set for the variable of Key=K1. Also, Value=V1 is registered for the variable of Key=K2 and synchronization destination is not specified. The variable synchronization 103 illustrated in FIG. 1 accesses the data structure of the variable set 101 as described above. When for example Value=V0 has been updated for the variable of Key=K1 as a result of this, node B serving as the synchronization destination and the Value of the variable corresponding to Key=K1 in variable set VS1 are updated to the same values.

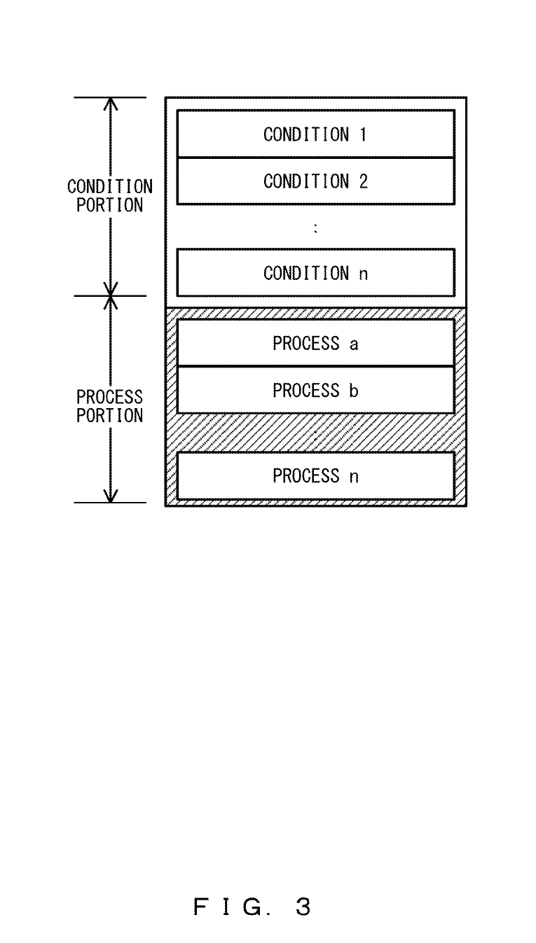

FIG. 3 illustrates a data structure of one of the CBs 105 in the CS 104 illustrated in FIG. 1. The CB 105 includes a condition portion and a process portion. A condition portion may include a plurality of conditions 1, 2, . . . n, and a process portion may also include a plurality of processes a, b, . . . n. The SFE 102 illustrated in FIG. 1, when reading the CB 105, executes respective processes in the process portion and sequentially evaluates respective conditions in the condition portion. Each CB 105 may include both a condition portion and a process portion and may include one of a condition portion and a process portion.

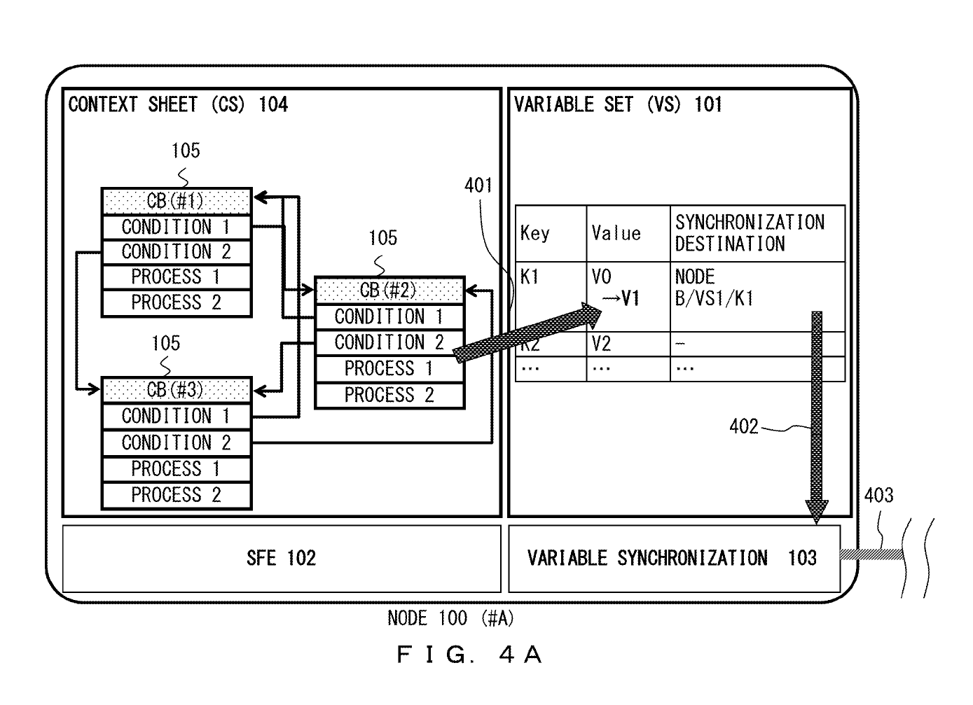

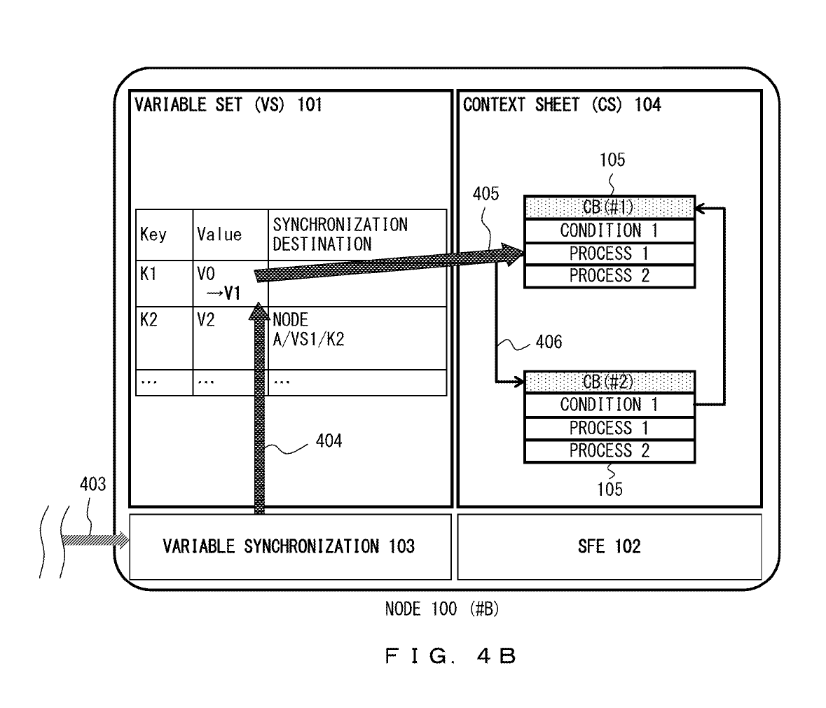

FIGS. 4A and 4B are an operation explanation view illustrating a relationship between a state transition process based on the execution, by the SFE 102, of each CB 105 in the CS 104 and a synchronization process, executed by the variable synchronization 103, of respective variables in the respective variable sets 101 between the nodes 100.

For example, the SFE 102 of node 100 (#A) reads the CS 104 in the node of the SFE 102, executes the process portion (processes 1 and 2) of first CB 105 (#1), and sequentially evaluates the condition portion (conditions 1 and 2). When for example the conditional expression of condition 1 has become true as a result of this, the state transition to second CB 105 (#2) occurs. Similarly, the SFE 102 of node 100 (#B) reads the CS 104 of the node of the SFE 102, executes the process portion (processes 1 and 2) of first CB 105 (#1), and evaluates the condition portion (condition 1). When for example the conditional expression of condition 1 has become true, the state transition to second CB 105 (#2) occurs. Note that CB 105 (#1) and CB 105 (#2) of node 100 (#B) maybe different from the CB 105(#1) and the CB 105(#2) of node 100 (#A). When the state has transitioned to the CB 105 that represents termination, the SFE 102 terminates the evaluation. The SFE 102 only performs state transition and does not perform processes for the CB 105 in which only the condition portion is set. Also, the SFE 102 performs a process described in the process portion after the state transition and terminates the operation of the CS 104 for the CB 105 in which the process portion is set and the condition portion is not set (, an example of which is the CB 105 representing termination or the like).

As a result of the execution, by the SFE 102 of the node 100 (#A), of process 1 in the process portion of CB 105 (#2), an update request is issued for the variable of Key=K1 in the variable set 101 of node 100 (#A) as depicted by for example an arrow 401.

The variable synchronization 103 of node 100 (#A) updates the Value for the variable of Key=K1 in the variable set 101 of node 100 (#A) from V0 to V1 when the process of the above update request is executed by the SFE 102.

As depicted by arrow 402, the variable synchronization 103 of node 100 (#A) recognizes that synchronization destination=node B/VS1/K1 (see FIG. 2B) is specified for the variable corresponding to Key=K1 specified by the above request.

The variable synchronization 103 of node 100 (#A) transmits, from the communication device 109 illustrated in FIG. 1, a request message requesting that the Value of the variable corresponding to Key=K1 in the variable set 101 of node 100 (#B) specified by the synchronization destination of the variable synchronization 103 be updated to V1. In the packet of that request message, the address of node 100 (#B) as the destination and the address of node 100 (#A) as the transmission source are specified, and synchronization destination “VS1/K1” and update data “V1” are stored in the data portion.

This request message is received by the communication device 109 of node 100 (#B) and given to the variable synchronization 103 of node 100 (#B) as depicted by arrow 403.

The variable synchronization 103 of node 100 (#B) reads the received request message and thereby searches for the variable corresponding to Key=K1 in the variable set 101=VS1 of the node of the variable synchronization 103 so as to update the Value of the variable to V1, as depicted by arrow 404.

The SFE 102 of node 100 (#B) reads the CS 104 of the node of the SFE 102 and thereby evaluates for example the conditional expression of condition 1 of CB 105(#1). At this timing, a reference request to the variable corresponding to for example Key=K1 in the variable set 101 of the node of the SFE 102 issued. When the above reference request is issued, the variable synchronization 103 of node 100 (#B) obtains the Value of the variable corresponding to Key=K1 in the variable set 101 of the node of the variable synchronization 103 and returns the obtained Value to the SFE 102. In this manner, the SFE 102 of node 100 (#B) evaluates for example the conditional expression of condition 1 of CB 105(#1), and thereby monitors whether or not the Value of the variable corresponding to Key=K1 in the variable set 101 of the SFE 102 has been changed from V0 to V1. When for example the evaluation result of the conditional expression of condition 1 of CB 105 (#1) is false, the SFE 102 of node 100 (#B) repeatedly executes the evaluation of the conditional expression of same condition 1. When the Value of the variable corresponding to Key=K1 in the variable set 101 of the SFE 102 of node 100 (#B) is changed to V1 and the evaluation result of the conditional expression of condition 1 of CB 105 (#1) has become true, the state transition to CB 105 (#2) is caused. As a result of this, the SFE 102 of node 100 (#B) executes processes 1 and 2 of the new CB 105(#2).

As examples of application of variable synchronization between nodes 100 (#A) and 100 (#B) as illustrated in FIGS. 4A and 4B described above, the following examples are possible. Node 100 (#A) is for example a gas-leak alert sensor provided in standard homes. Node 100 (#B) is for example a gas-leak report device provided in a security company. Node 100 (#B) maybe replaced by a gateway or a server as long as it is possible to implement the functions illustrated in FIG. 1. For example, in node 100 (#A), condition 1 of CB 105 (#1) is monitoring the value of the gas sensor. When the gas sensor indicates an abnormal value, the state transition to CB 105 (#2) occurs. In CB 105 (#2) of node 100 (#A), the gas-leak alert buzzer sounds in accordance with process 2. At the same time, the Value of the variable corresponding to Key=K1 in the variable set 101 in node 100 (#A) is updated by process 1 from V0, which represents that there are no gas leaks, to V1, which represents there is a gas leak,. In response to this update, the Value of the variable corresponding to Key=K1 in the variable set 101 of node 100 (#B) in the security company is synchronizedly updated to V1, representing a gas leak in accordance with the variable synchronization between nodes 100 (#A) and 100 (#B). In the gas-leak report device of node 100 (#B), condition 1 of CB 105 (#1) is monitoring the occurrence of the gas leak in node 100 (#A). The fact that the Value corresponding to Key=K1 in the variable set 101 of node 100 (#B) has been updated to V1 due to the occurrence of the gas leak in node 100 (#A) is detected on the basis of the evaluation of condition 1=true in CB 105(#1). As a result of this, in node 100 (#B), the state transition to CB 105 (#2) occurs. In CB 105 (#2) of node 100 (#B), the occurrence of the gas leak is displayed by process 1 or 2 in an alerting system of the security company and procedures for gas leak are followed.

In the above process example, communication traffic does not occur from node 100 (#A) to node 100 (#B) under a situation where no gas leaks have occurred in node 100 (#A). Only when a gas leak has occurred, P2P communication traffic based on variable synchronization occurs.

The present embodiment implements distributed processing that can be arranged in flexible units of execution based on the CS 104 on the side of the node 100, and thereby distribution of processing (state transition) is made possible. This makes it possible to perform data processing in the nodes 100 alone, eliminating the necessity of analyzing a large amount of data on the server side and processes on the side of the server are reduced so as to permit swift responses.

Also, according to the present embodiment, it is possible to make a large indefinite number of the nodes 100, gateways or servers share the Value of the variable corresponding to each Key by using the information of the synchronization destination corresponding to the Key of the variable set 101 so as to achieve synchronization autonomously. This is different from the conventional configuration in which a particular server etc. has managed the states of the respective nodes 100 in a concentrated manner. This arrangement of the variable synchronization 103 makes it possible to report only information of variables that has to be reported from the node 100 to a different node 100, a gateway, a server or the like at a preferable timing and by unicast (P2P) communication in a autonomous and distributed manner. As a result of this, even in a large scale sensor network such as one that is assumed to have ten thousand nodes or more, it is possible to distribute traffic so as to avoid the occurrence of congestion.

Further, the autonomous distributed processing makes it possible to eliminate the effects on the entire processing on the server side even when the functions of one of the nodes 100 have stopped. It is also possible to perform changing or addition of processes in the nodes 100 easily by the updating the CBs 105 and the variable set 101.

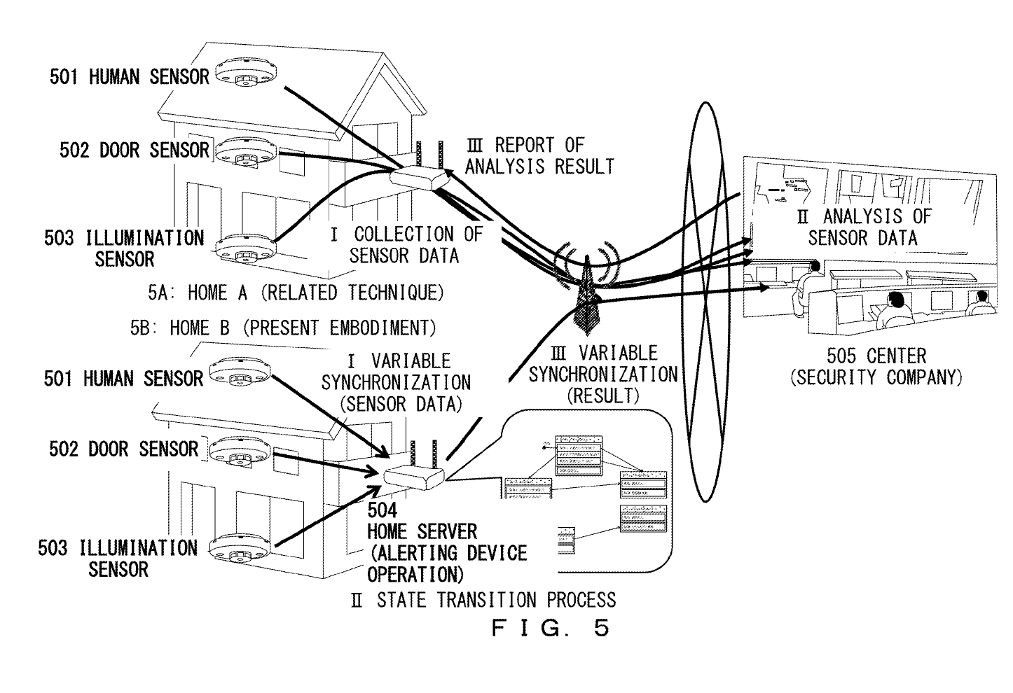

FIG. 5 illustrates an application example in which the present embodiment is applied to a home security system.

Each home is provided with a human sensor 501, a door sensor 502 and an illumination sensor 503.

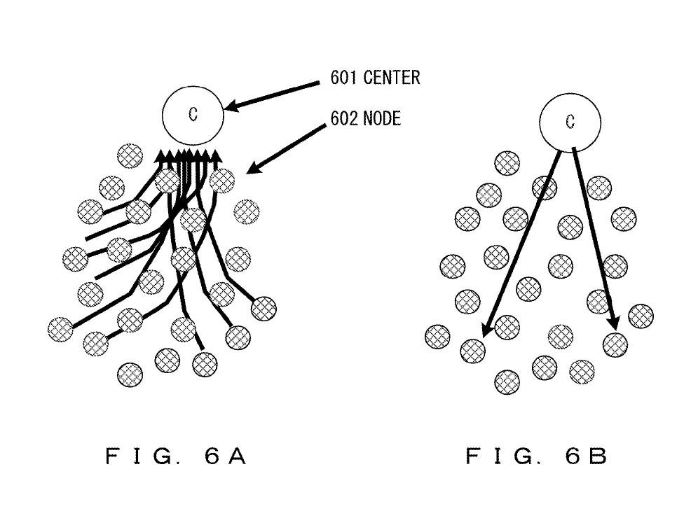

Conventionally, pieces of data from all the sensors 501, 502 and 503 have been collected to a center 505 such as a security company or the like (I collection of sensor data) and analyzed (II analysis of sensor data) as illustrated as home A in FIG. 5A. Thereafter, the analysis result has been reported to home A (III report of analysis result). Accordingly, when the number of nodes 602 has increased as illustrated in FIG. 6A, congestion became more likely to occur at a section around a GW or a center 601 in I collection of sensor data in FIG. 5A. Also, several days have been taken to perform the data processing in II analysis of sensor data in FIG. 5A. Also, reports in III report of analysis result from GW or the center 601 to the respective nodes 602 in FIG. 5A are made by P2P communication.

By contrast, according to the present embodiment, distributed processing is executed basically in a home server 504 on the side of the sensor net as illustrated in home B in FIG. 5B. Specifically, each node constituting the human sensor 501, the door sensor 502 and the illumination sensor 503 and the home server 504 have the configuration of the present embodiment illustrated in FIG. 1. Each piece of sensor data from each of the human sensor 501, the door sensor 502 and the illumination sensor 503 is synchronized, by the variable synchronization 103 according to the present embodiment (I variable synchronization in FIG. 5B), with the respective corresponding variables of the variable set 101 in the home server 504. Also, the SFE 102 in the home server 504 executes the state transition process by each CB 105 (FIG. 1) of the CS 104 of the SFE 102 (II state transition process in FIG. 5B). As a result of this, when a report has to be made to the center 505 of the security company or the like, the SFE 102 of the home server 504 executes a prescribed process of the CB 105 so as to update the Value of the corresponding variable of the variable set 101 of the device of the SFE 102. In this variable, a variable of the variable set 101 in the center 505 is specified as a synchronization destination and thereby synchronization is implemented for the states of the respective sensors 501, 502 and 503 between the home server 504 and the center 505.

This configuration makes it possible to swiftly perform distributed processing by using the SFE 102 on the side of the home server 504 not through the center 505 in an emergency process such as for example the alerting device operation or the like. At the same time, the variable synchronization 103 between the respective sensors 501, 502, and 503 and the home server 504 and the variable synchronization 103 between the home server 504 and the center 505 make it possible to efficiently make reports to the center 505 only in cases of for example abnormality, which also makes it possible to avoid network congestion, leading to enhanced scalability.

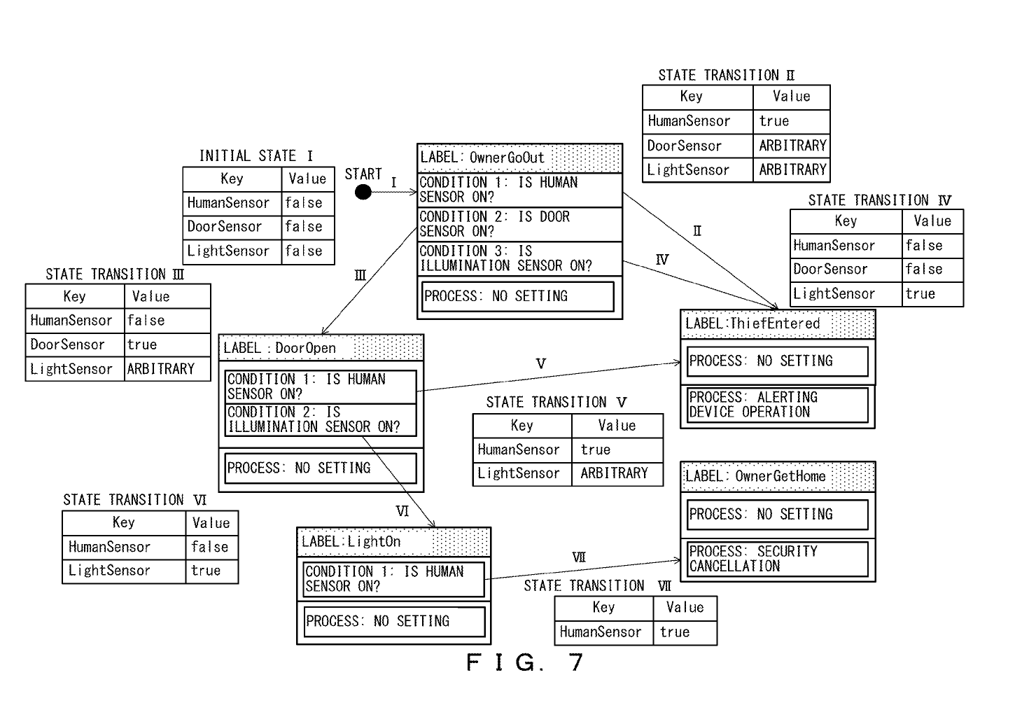

FIG. 7 illustrates an example of state transition of the CB 105 and an example of updating of the variable set 101 in the home server 504 in an application example of home security illustrated in FIG. 5B.

The respective Values corresponding to “HumanSensor”, “DoorSensor” and “LightSensor” in the variable set 101 are automatically updated from the nodes of the respective sensors 501, 502 and 503 illustrated in FIG. 5B by the variable synchronization 103. The respective Values may take the value of “false” or “true”. When the Value of

Key “HumanSensor” has become “true”, ON in the human sensor 501 is detected. When the Value of Key “DoorSensor” has become “true”, ON in the door sensor 502 is detected. When the Value of Key “LightSensor” has become “true”, ON in the illumination sensor 503 is detected.

As illustrated in FIG. 7, sequential state transition occurs, triggered by the detection (ON) of the respective sensors 501, 501 and 503. The security system is canceled in the order from the state transition in the case where no abnormality exists to the case where the door sensor 502 is ON, the case where the illumination sensor 503 is ON and the case where the human sensor 501 is ON, and situations other than these situations are regarded as abnormal so that the alerting device is made to operate.

The starting CB 105 has transitioned sequentially from “OwnerGoOut” to “OwnerGetHome” or “ThiefEntered”, which is the termination CB 105.

The state immediately after reading the CS 104 is initial state I in FIG. 7, and the state transitions to the CB 105 of “OwnerGoOut”. No processes are specified regarding “OwnerGoOut”. Accordingly, the process portion is not executed. Next, the evaluation of the condition portion of “OwnerGoOut” starts from condition 1.

When condition 1 is “true” (the Value of Key “HumanSensor” is “true”), the state transitions to the CB 105 of “ThiefEntered” (II in FIG. 7). The CB 105 of “ThiefEntered” makes the alerting device operate as the process. No conditions are set for the CB 105 of “ThiefEntered”, and accordingly the execution is terminated after the execution for this CB 105.

When condition 1 is “false” (the Value of Key “HumanSensor” is “false”) in initial state I, condition 2 is evaluated. When condition 2 is “true” (the Value of Key

“DoorSensor” is “true”), the state transitions to the CB 105 of “DoorOpen” (III in FIG. 7). When condition 2 is “false” (the Value of Key “DoorSensor” is “false”), condition 3 is evaluated.

The state transitions to the CB 105 that indicates the termination in a similar manner, and the process portion is executed.

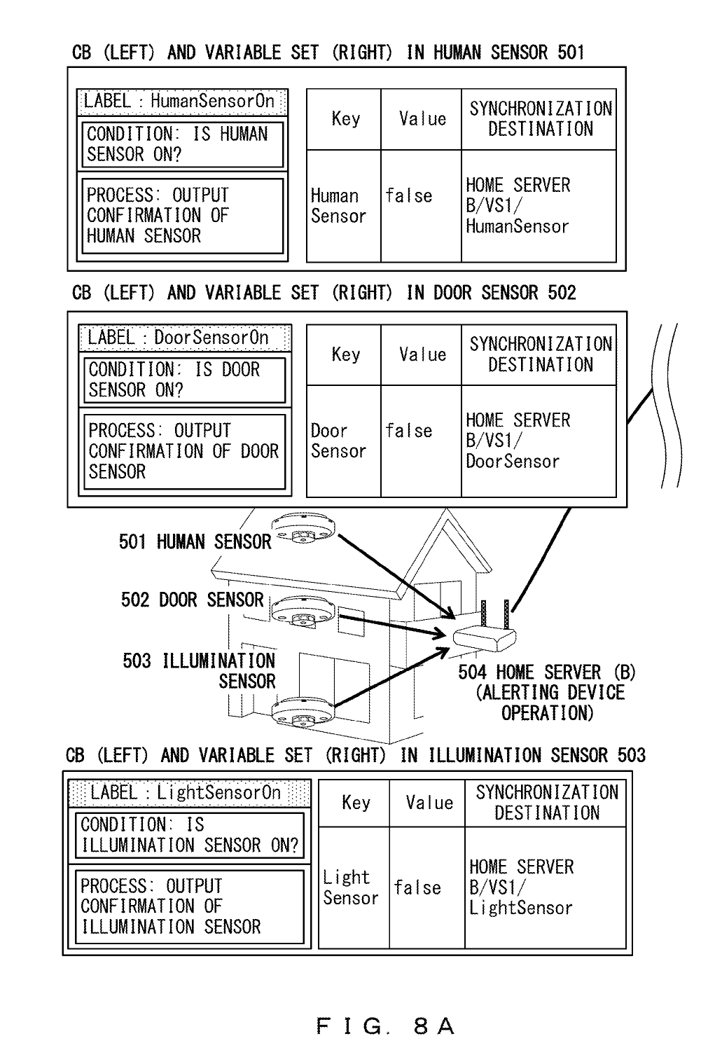

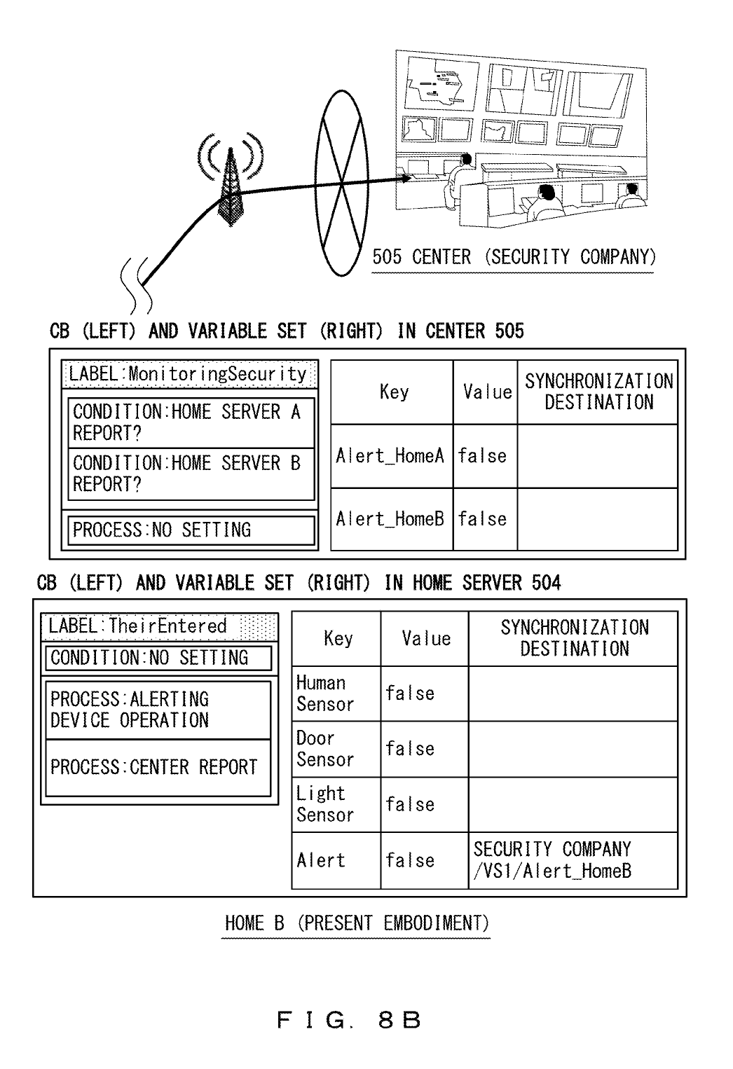

FIGS. 8A and 8B illustrate an example of state transition of the CB 105 and an example of updating the variable set 101 in a case where the sensor nodes 501, 502 and 503, the home server 504 and the center 505 perform distributed processing, as an example of applying the configuration in FIG. 1 to a home security system.

The SFE 102 of the node 100 of the human sensor 501 executes the CS 104 in which the CB 105 of “HumanSensorOn” is registered. Thereby, the SFE 102 checks the output (ON or OFF) of the human sensor 501, and writes the result to the Value corresponding to Key “HumanSensor” in the variable set 101 of the node of the human sensor 501. When this is performed, Key “HumanSensor” (home server B/VS1/HumanSensor” is specified in “VS1” in the variable set 101 of the home server 504=home server B as the synchronization destination. Accordingly, immediately after the human sensor 501 has written the Value to “HumanSensor”, the variable synchronization 103 in the human sensor 501 performs communication with the variable synchronization 103 in the home server 504 (home server B). Thereafter, the variable synchronization 103 in the home server 504 updates the Value of Key “HumanSensor” in “VS1” of the variable set 101 of the home server 504.

Similarly, the door sensor 502 and the illumination sensor 503 confirm outputs of the respective sensors and respectively update the Values of Key “DoorSensor” and Key “LightSensor” of the nodes of the door sensor 502 and the illumination sensor 503. Then, the Variable synchronization 103 of the respective nodes in the respective sensors 502 and 503 perform communications with the variable synchronization 103 of the home server 504 (home server B) of the synchronization destination. Thereby, the Values of the respective Keys “DoorSensor” and “LightSensor” in “VS1” of the variable set 101 of the home server 504 are updated.

The home server 504 (home server B) makes the CB 105 perform state transition by using the respective Values of the respective Keys corresponding to the human sensor 501, the door sensor 502 and the illumination sensor 503, respectively. When one of the state transitions of II, IV and V in FIG. 7 is corresponded, the SFE 102 of the home server 504 transitions to the CB 105 of “ThiefEntered”. When this is performed, the SFE 102 of the home server 504 (home server B) executes the process of making the alerting device operate, and executes the process of making a report to a center. The SFE 102 and the variable synchronization 103 of the home server 504 executes the process of making a report to a center and thereby updates the Value of Key “Alert” of the variable set 101 in the device of the SFE 102 and the variable synchronization 103 to “true”. Thereafter, the Value of Key “Alert_HomeB” of the variable set 101 of the center 505 (security company) as the synchronization destination is updated to “true”, and an alert is issued.

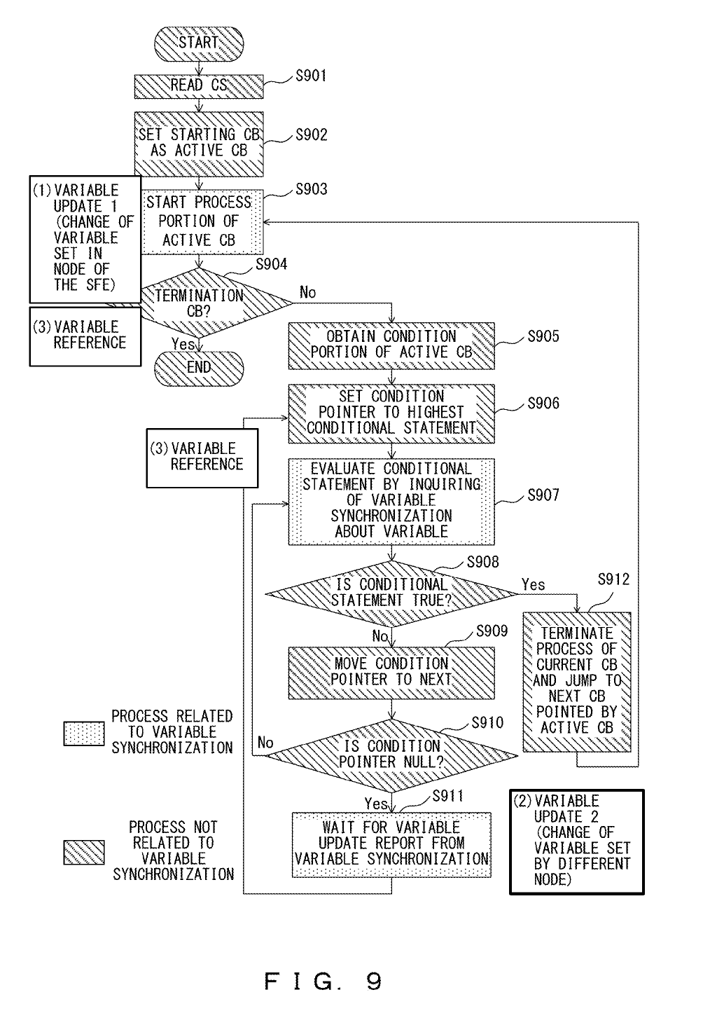

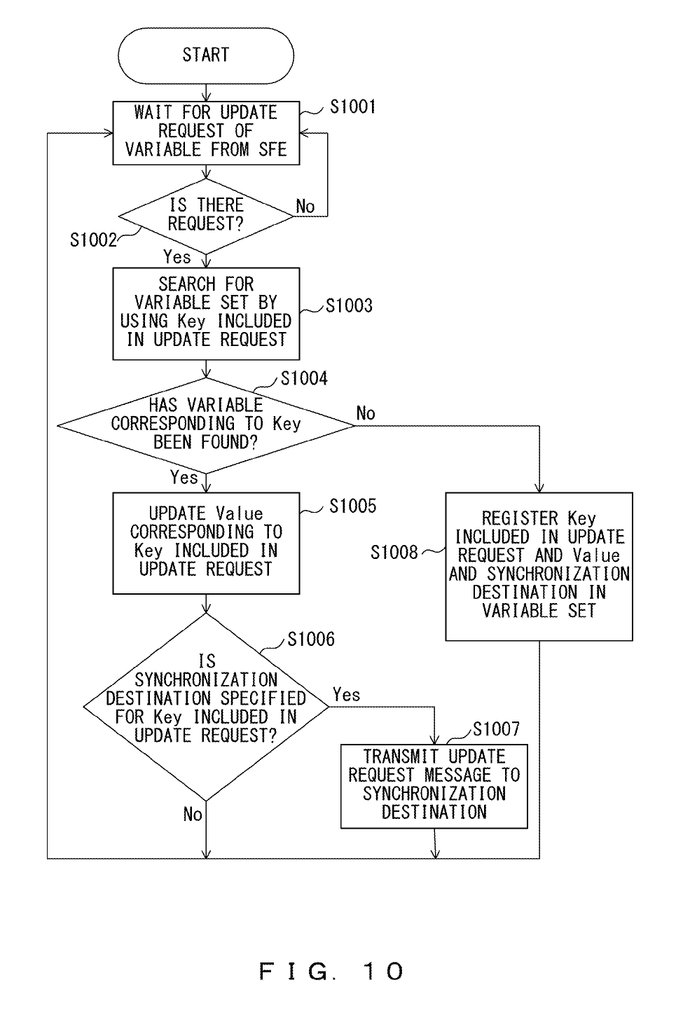

FIG. 9 is a flowchart illustrating a control operation of the SFE 102 in FIG. 1. This control operation is implemented as a process in which the CPU 110 and the OS 108 illustrated in FIG. 1 execute a control program stored in a memory (not illustrated).

When the process of the SFE 102 has started, the SFE 102 first reads the CS 104 (FIG. 1) of the device of the SFE 102 (step S901).

Next, the SFE 102 sets the starting CB 105 registered in the CS 104 to the active CB 105 (step S902). Thereby, the internal processes 106 corresponding to the starting CB 105 is generated.

In the generated internal processes 106, the SFE 102 starts the execution of the process portion (see FIG. 3) (step S903) of the activated CB 105 (, which is initially the starting CB 105). In the execution of the process portion, the SFE 102 may issue, to the variable synchronization 103 of the device of the SFE 102, an update request or a reference request for the variable of the Key in the variable set 101 of the device of the SFE 102. An example of this is a case where the SFE 102 of node 100 (#A) executes process 1 of the process portion of CB 105 (#2) in FIGS. 4A and 4B. In such a case, as described above, an update request is issued for example for the variable of Key=K1 in the variable set 101 of node 100 (#A) as depicted by arrow 401. Alternatively, an example of this is a case where the SFE 102 of the home server 504 executes process “Center Report” in the process portion of the CB 105 of

“ThiefEntered” so as to update the Value of Key “Alert” in the variable set 101 of the server of the SFE 102 from “false” to “true” in FIGS. 8A and 8B. Also, in the execution of the process portion, the SFE 102 may execute for example a process of confirming an output of hardware of a sensor in addition to updating of the variable. An example of this is a case where the SFE 102 of the node of the human sensor 501 executes process “output confirmation of human sensor” in the process portion of the CB 105 of “HumanSensorOn” in FIGS. 8A and 8B.

The SFE 102 determines whether or not the currently active CB 105 is indicating the termination (step S904) after the execution of the process portion. Whether or not the CB 105 is indicating the termination may be determined on the basis of whether or not a condition portion (see FIG. 3) has been set for that CB 105.

When the condition portion has not been set, the state does not transition to different CB 105 after the process portion of the CB 105 has been executed in step S903, and accordingly the SFE 102 terminates the process of the CS 104 (YES in step S904).

When the currently active CB 105 has not terminated and the determination result in step S904 is NO, the SFE 102 obtains the condition portion of the active CB 105 (step S905).

As explained in FIG. 3, it is possible to register a plurality of conditions (conditional statements) 1 through n in the condition portion of the CB 105. Accordingly, the SFE 102 points to each condition in the condition portion by using a condition pointer. The SFE 102 first sets a condition pointer to the highest conditional statement in the condition portion (step S906).

The SFE 102 evaluates a conditional statement (step S907). When a variable is included in a conditional statement, the SFE 102 issues, to the variable synchronization 103 (see FIG. 1) in the device of the SFE 102, a reference request of the Value of the Key corresponding to that variable in the variable set 101 (see FIG. 1) of the device of the SFE 102. As a result of this, the SFE 102 evaluates the conditional expression including that variable by using the Value returned from the variable synchronization 103. An example of this is a case where the SFE 102 of node 100 (#B) evaluates the conditional statement of condition 1 of for example CB 105 (#1) so as to evaluate the Value of the variable corresponding to Key=K1 in the variable set 101 of the node of the SFE 102 in FIGS. 4A and 4B. Also, the SFE 102 may perform evaluation in which the SFE 102 evaluates hardware output of for example a sensor in addition to referring to a variable so as to confirm whether or not the sensor has become ON in the evaluation of a conditional statement. An example of this is a case where the SFE 102 of the node of the human sensor 501 evaluates condition “is human sensor ON?” of the condition portion of the CB 105 of “HumanSensorOn” in FIGS. 8A and 8B.

After evaluating a conditional statement, the SFE 102 determines whether or not that conditional statement is true (step S908).

When the conditional statement is not true (i.e., the conditional statement is false) and the determine result is NO in step S908, the SFE 102 moves the condition pointer to the next condition (step S909).

The SFE 102 determinations whether or not the condition portion has no more conditional statement and the condition pointer is null (step S910).

When the condition pointer is not null and the determination result in step S910 is NO, the process proceeds to the process of step S907, and the evaluation of the next conditional statement newly pointed by the condition pointer is repeated. An example of this is a case where condition 2 is evaluated when condition 1 is false and condition 3 is further evaluated when condition 2 is also false in the evaluation of the condition portion of the CB 105 of “OwnerGoOut” in FIG. 7.

When the condition portion does not have any more conditional statements and the condition pointer has become null so that the determination result in step S910 has become YES, the next process is executed. The SFE 102 waits for a prescribed period of time for the fact to be reported by the variable synchronization 103 (step S911) that one of variables in the variable set 101 of the device of the SFE 102 has been updated by a different device (a node, a server, a gateway, etc.). An example of this is a process in which the SFE 102 of the center 505 terminates the evaluation of respective conditions “home server A report?” and “home server B report?” of the CB 105 of “MonitoringSecurity” and thereafter performs waiting in FIGS. 8A and 8B. In such a case the SFE 102 waits for the variable of Key “Alert_HomeA” or the variable of Key “Alert_HomeB” in the variable set 101 of the server of the SFE 102 to be updated by the variable synchronization from the home server 504 etc. Alternatively, the SFE 102 may execute a process in which the SFE 102 waits for a prescribed period of time for an output of a sensor to change. An example of this is a process in which the SFE 102 of the human sensor 501 terminates the evaluation of condition “is human sensor OK?” of the CB 105 of “HomeSensorOn” and thereafter performs waiting. In such a case, for example, the SFE 102 waits for a prescribed period of time for a hardware output of the human sensor 501 to change.

Thereafter, the SFE 102 returns to the process of step S906, again sets the condition pointer to the highest conditional statement in the condition portion of the currently active CB 105, and repeatedly executes evaluation processes of respective conditional statements in steps S907 through S910 described above.

When a conditional statement has been determined to be true in the determination in step S908, the SFE 102 terminates the process of the currently active CB 105, and jumps (state transition) to the next CB 105 indicated by the currently active CB 105 (YES in determination in step S908 →step S912). An example of this is a case where the SFE 102 of node 100 (#B) has determined that the Value of the variable corresponding to Key=K1 in the variable set 101 of the node of the SFE 102 has been changed to V1 and the evaluation result of the conditional expression of condition 1 of the CB 105 (#1) has become true in FIGS. 4A and 4B. In such a case, the SFE 102 causes state transition to CB 105(#2). Another example is a case where the evaluation of condition 1 of the CB 105 of “OwnerGoOut” has become true and state transition to the CB 105 of “ThiefEntered” occurred.

As described above, it is possible for the SFE 102 to execute the process portion or evaluate the condition portion of each of the CBs 105 in the CS 104 while performing state transition so as to perform distributed processing in the device of the SFE 102 (a node, a gateway, a server, etc.).

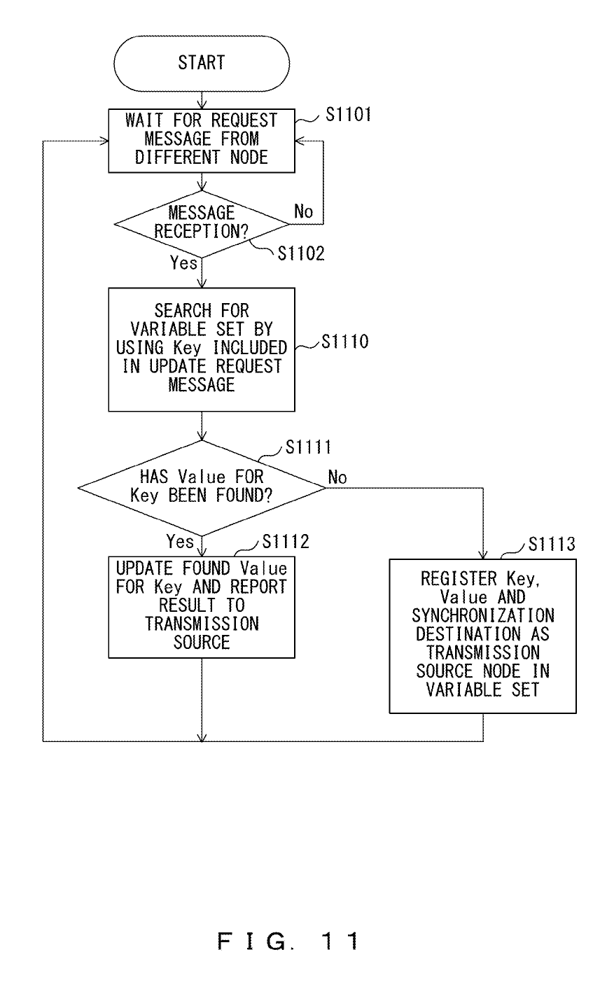

FIG. 10 is a flowchart explaining a control operation of a variable update process (first) in the variable synchronization 103 in FIG. 1. This control operation is performed by the variable synchronization 103 that has received an update request of a variable from the SFE 102 of the device of the variable synchronization 103. This control operation is implemented as a process in which the CPU 110 and the OS 108 in FIG. 1 execute a control program stored in a memory (not illustrated).

The variable synchronization 103 first waits for an update request of a variable from the SFE 102 (step S1001), determines whether or not there was a request (step S1002), and repeats the waiting when there were not (determination in step S1002 is NO→repeating of step S1001).

When an update request of a variable from the SFE 102 is generated and the determination result in step S1002 has become YES, the variable synchronization 103 executes a series of the following processes. An example of this is a case where an update request for the variable of Key=K1 in the variable set 101 in node 100 (#A) is issued as depicted by arrow 401 as a result of the SFE 102 of node 100 (#A) executing process 1 in the process portion in the CB 105(#2) in FIGS. 4A and 4B.

First, the variable synchronization 103 searches the variable set 101 (see FIG. 2) of the device of the variable synchronization 103 by using the Key included in the update request (step S1003).

The variable synchronization 103 determines whether or not a variable corresponding to the Key has been found (step S1004).

When a variable corresponding to the Key has been found and the determination in step S1004 has become YES, the variable synchronization 103 updates the Value of the variable corresponding to the Key included in the update request by using the Value included in the update request (step S1005). An example of this is a case where the Value corresponding to the variable of Key=K1 in the variable set 101 of node 100 (#A) is updated from V0 to V1 when the SFE 102 has executed the process of the update request in FIGS. 4A and 4B.

Next, the variable synchronization 103 determines whether or not variables corresponding to the Keys included in the update request include a synchronization destination (see FIG. 2) (step S1006).

When a synchronization destination is not included and the determination in step S1006 is NO, the variable synchronization 103 returns to the waiting process in steps S1001 and S1002.

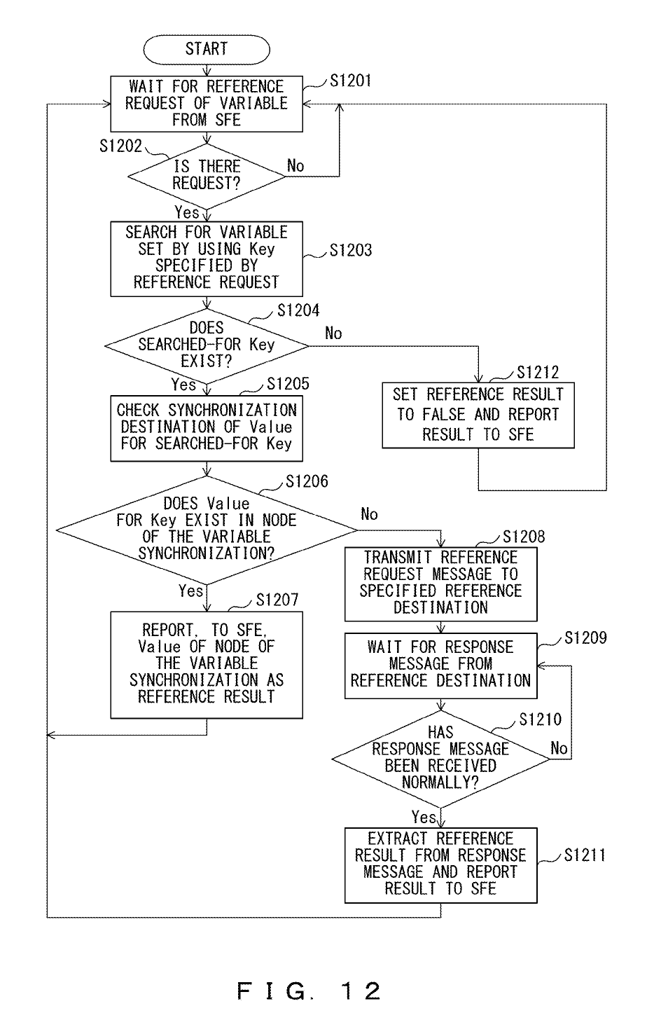

When a synchronization destination is included and the determination in step S1006 has become YES, the variable synchronization 103 transmits an update request message to that synchronization destination from the communication device 109 illustrated in FIG. 1 (step S1007). For this transmission, information indicating that the type of the message is an update request has been added to the header of the update request message although this is not illustrated. Thereafter, the variable synchronization 103 returns to the waiting process in steps S1001 and S1002. For example, in FIGS. 4A and 4B, the variable synchronization 103 of node 100 (#A) recognizes, as depicted by arrow 402, that synchronization destination=node B/VS1/K1 has been specified for the variable corresponding to Key=K1 specified by the above request. Then, the variable synchronization 103 of node 100 (#A) transmits a request message requesting that the Value of the variable corresponding to Key=K1 in the variable set 101 of node 100 (#B) specified by that synchronization destination be updated to V1. It is also possible to include a process of receiving an update result from the synchronization destination after the transmission of an update request message (this corresponds to the reporting in step S1112 in FIG. 11, which will be described later).

When a variable corresponding to the Key is not found after searching the variable set 101 by using the Key included in the update request and the determination in step S1004 is NO, the variable synchronization 103 executes the next process. The variable synchronization 103 newly registers the Key included in the update request and the Value or the synchronization destination in the variable set 101 of the device of the variable synchronization 103 in for example the data format illustrated in FIG. 2A (step S1008). Thereafter, the variable synchronization 103 returns to the waiting process in steps S1001 and S1002.

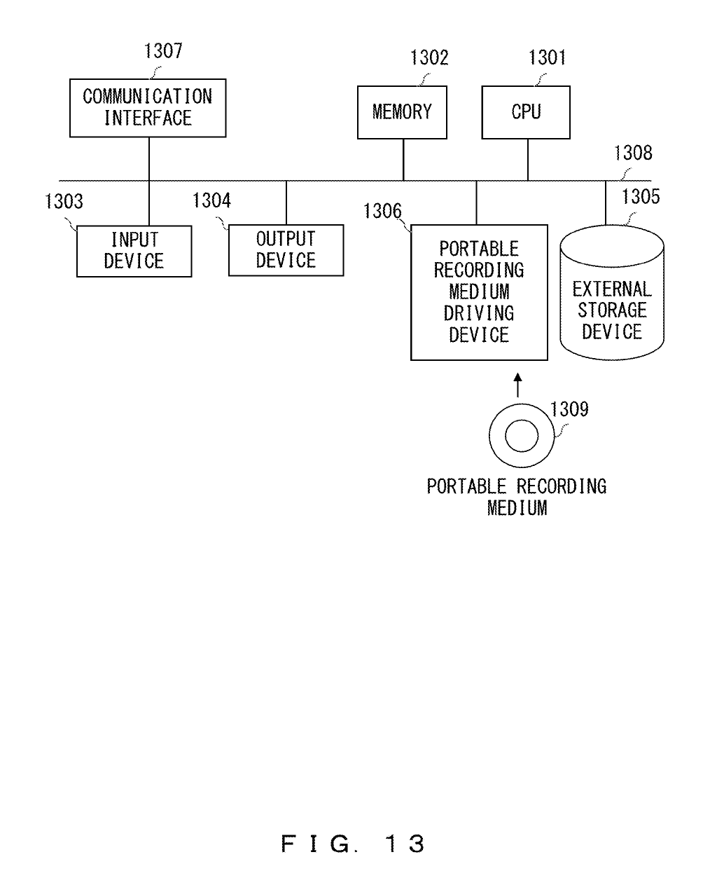

FIG. 11 is a flowchart explaining a control operation of a variable update process (second) in the variable synchronization 103 illustrated in FIG. 1. This control operation is performed by the variable synchronization 103 of the device of the variable synchronization 103 receiving an update request message transmitted to the device of the variable synchronization 103 from the variable synchronization 103 of a different device in step S1007 in FIG. 10 or step S1208 in FIG. 12, which will be explained later. This control operation is implemented as a process in which the CPU 110 and the OS 108 in FIG. 1 execute a control program stored in a memory (not illustrated).

The variable synchronization 103 first waits for a variable update request message from a different node (or a gateway or a server) (step S1101). The communication device 109 illustrated in FIG. 1 determinations whether or not the message has been received (step S1102), and repeats the waiting process when the message has not been received (NO in the determination in step S1102→repeating of step S1101).

When the reception of the update request message occurred and the determination in step S1102 has become YES, the variable synchronization 103 executes a series of the following processes. An example of this is a case where a request message transmitted from node 100 (#A) is received by node 100 (#B) and is given to the variable synchronization 103 of node 100 (#B) as depicted by arrow 403 in FIGS. 4A and 4B.

When an update request message has been received and the determination in step S1102 is YES, the variable synchronization 103 searches the variable set 101 (see FIG. 2) in the device of the variable synchronization 103 by using the Key included in the update request message (step S1110).

The variable synchronization 103 determines whether or not a variable for the Key has been found (step S1111).

When a variable corresponding to the Key has been found and the determination in step S1111 has become YES, the variable synchronization 103 updates the Value of the found variable that corresponds to Key in the variable set 101 by using the Value included in the update request message. Then, the variable synchronization 103 reports the update result to the transmission source of the update request message (step S1112). Thereafter, the variable synchronization 103 returns to the waiting process in steps S1101 and S1102. An example of this is a case where the variable synchronization 103 of node 100 (#B) searches, as depicted by arrow 404, for a variable corresponding to Key=K1 in the variable set 101=VS1 of the node of the variable synchronization 103 and updates the Value of the variable to V1 in FIGS. 4A and 4B.

When a variable corresponding to the Key has not been found and the determination in step S1111 is NO, the variable synchronization 103 executes the next process. The variable synchronization 103 newly registers the Key and the Value included in the update request in the variable set 101 of the device of the variable synchronization 103 in for example the data format illustrated in FIG. 2A (step S1113). Thereafter, the variable synchronization 103 returns to the waiting process in steps S1101 and S1102.

FIG. 12 is a flowchart explaining a control operation of a variable reference process in the variable synchronization 103 in FIG. 1. This control operation is performed by the variable synchronization 103 that has received a reference request for a variable from the SFE 102 of the device of the variable synchronization 103. This control operation is implemented as a process in which the CPU 110 and the OS 108 in FIG. 1 execute a control program stored in a memory (not illustrated).

The variable synchronization 103 first waits for a reference request for a variable from the SFE 102 (step S1201), determines whether or not there was a request (step S1202), and repeats the waiting when there was not (determination in step S1202 is NO→repeating of step S1201).

When the reception of the reference request for a variable from the SFE 102 occurred and the determination in step S1202 has become YES, the variable synchronization 103 executes a series of the following processes. An example of this is a case where when for example the SFE 102 of node 100 (#B) evaluates the conditional expression of condition 1 of CB 105 (#1), a reference request to the variable corresponding to Key=K1 in the variable set 101 of the node of the SFE 102 is issued in FIGS. 4A and 4B.

First, the variable synchronization 103 searches the variable set 101 in the device of the variable synchronization 103 by using the Key specified by the reference request (see FIG. 2) (step S1203).

The variable synchronization 103 determines whether or not a variable corresponding to the Key exists (step S1204).

When a variable corresponding to the Key exits and the determination in step S1204 has become YES, the variable synchronization 103 checks, in the variable set, the synchronization destination (see FIG. 2) of the Value of the variable corresponding to the Key included in the reference request (step S1205).

The variable synchronization 103 further determines whether or not the Value of the variable corresponding to the Key included in the reference request in the variable set 101 of the node of the variable synchronization 103 (or a gateway or a server) exists (step S1206).

When the Value exists and the determination in step S1206 is YES, the variable synchronization 103 reports that Value in the node or the like of the variable synchronization 103 as a reference result to the SFE 102 (step S1207). Thereafter, the variable synchronization 103 returns to the waiting process in steps S1201 and S1202.

When the Value does not exist and the determination in step S1206 is NO, the variable synchronization 103 transmits a reference request message to the reference destination specified by the synchronization destination of the variable corresponding to the Key included in the reference request via the communication device 109 (FIG. 1) (step S1208).

The variable synchronization 103 waits for a response message corresponding to the above reference request message from the reference destination (step S1209). The communication device 109 illustrated in FIG. 1 determinations whether or not the response message has been received normally (step S1210), and repeats the waiting process when the response message has not been received (NO in the determination in step S1210→repeating of step S1209).

When the response message has been received normally and the determination in step S1210 has become YES, the variable synchronization 103 extracts a reference result from the response message and reports the result to the SFE 102 (step S1211). Thereafter, the variable synchronization 103 returns to the waiting process in steps S1201 and S1202.

FIG. 13 illustrates an example of a hardware configuration of a computer that is capable of implementing the above system as a software process.

The computer illustrated in FIG. 13 has a configuration that includes a CPU 1301, a memory 1302, an input device 1303, an output device 1304, an external storage device 1305, a portable recording medium driving device 1306 into which a portable recording medium 1309 is inserted, and a communication interface 1307, and these are connected to each other via a bus 1308. The configuration illustrated in FIG. 13 is an example of a computer that is capable of implementing the above system, and configurations of computers capable of implementing the above system are not limited to this configuration.

The CPU 1301 performs the entire control of such a computer. The memory 1302 is a memory such as a RAM or the like that temporarily stores a program or data stored in the external storage device 1305 (or a portable recording medium 1309) when a program is executed, data is updated or in other occasions. The CPU 1301 reads a program to the memory 1302 so as to execute the program, and thereby performs the entire control.

The input device 1303 detects an input manipulation made by a user through a keyboard, a mouse or the like so as to report the detection result to the CPU 1301, and the output device 1304 outputs, to a display device or a printer device, data transmitted under control of the CPU 1301.

The external storage device 1305 is for example a hard disk storage device. The external storage device 1305 is used mainly for storing various types of data or programs.

The portable recording medium driving device 1306 accommodates an optical disk, an SDRAM or the portable recording medium 1309 such as a compact flash, and has the function of assisting the external storage device 1305.

The communication interface 1307 is a device that connects communication lines of for example a LAN (Local Area Network) or a WAN (Wide Area Network).

The system according to the present embodiment is implemented by the CPU 1301 executing a program provided with the function that is realized by the flowcharts in FIG. 9 through FIG. 12 or the like. That program may be distributed in a state that for example it is recorded in the external storage device 1305 or the portable recording medium 1309, or may be obtained through a network by using the communication interface 1307.

As described above, the present embodiment makes it possible to realize distributed processing by using a node, a gateway or a server that constitutes a sensor network.

According to the present embodiment, it is possible to change a unit of execution (CB 105) in a flexible manner in accordance with the processing performance of the node 100 so as to distribute processing.

According to the present embodiment, it is possible to perform data processes in the node 100 in order to eliminate the necessity of analyzing a large amount of data in a center so that a swift response is made.

According to the present embodiment, it is possible to reduce network loads because the synchronization of distributed processing is realized by variable synchronization based on P2P instead of a centralized method.

According to the present embodiment, it is possible to avoid the occurrence of effects on the entire processing even when one of the nodes 100 is stopped.

Also, according to the present embodiment, it is possible to easily perform the changing/addition of processes in the node 100 or the like in units of the CBs 105.

As described above, according to the present embodiment, it is possible to change a unit of execution flexibly in accordance with the processing performance of a node and distribute processing. Because data process is performed in a node, eliminating the necessity of analyzing a large amount of data in a center, it is possible to make a swift response. Because the synchronization of distributed processing is realized by variable synchronization based on P2P instead of a centralized method, network loads are reduced. Thereby, it is possible to perform swift data process even in a large scale sensor network with for example in the order of ten thousand nodes.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer that executes distributed processing in a sensor network to execute a process comprising:
storing, as a variable set, a database of a variable that associates a key, a value and a synchronization destination corresponding to the key;
executing a process of requesting that the variable in the variable set of the computer be referred to or updated in a state and evaluating a condition while referring to the variable in the variable set of the computer so as to make the state transition to a different state; and
communicating the key specified by the request with the synchronization destination for the variable corresponding to the key specified by the request and synchronizing the value of the variable corresponding to the key specified by the request in the variable set in the computer and the value of the variable corresponding to the key specified by the request in the variable set of the synchronization destination when the process of requesting that the variable in the variable set of the computer be referred to or updated is executed.

2. The non-transitory computer-readable recording medium according to claim 1, wherein
the synchronizing includes:
referring to or updating the value of the variable corresponding to the key specified by the request in the variable set when the process of requesting that the variable in the variable set of the computer be referred to or updated is executed;
transmitting a request message requesting that the variable set specified by the synchronization destination be updated to the synchronization destination when the synchronization destination is specified for the variable corresponding to the key specified by the request; and
updating the value of the variable corresponding to the key specified by the request message in the variable set of the computer specified by the request message when the request message is received from a synchronization source device.

3. The non-transitory computer-readable recording medium according to claim 1, wherein
the evaluating includes:
sequentially reading contest boxes that are described in a context sheet, which is a file describing a state transition machine by combining the context boxes including condition portions describing conditions or process portions describing processes to be executed;
executing a process including the process of requesting that the variable in the variable set of the computer be referred to or updated by interpreting the process portion of the read context box; and
evaluating the condition portion of the read context box while referring to the variable in the variable set of the computer and further evaluating the condition portion in accordance with a result of the evaluation or transitioning to reading of a different context box.

4. The non-transitory computer-readable recording medium according to claim 1, wherein
the synchronizing includes communicating the key specified by the request with the synchronization destination by unicast.

5. A distributed processing device that performs distributed processing in a sensor network, the distributed processing device comprising:
a storage device configured to store, as a variable set, a data base of a variable that associates a key, a value and a synchronization destination corresponding to the key; and
a processor configured to execute a process including:
executing a process of requesting that the variable in the variable set of the distributed processing device be referred to or updated in a state and evaluating a condition while referring to the variable in the variable set of the distributed processing device so as to make the state transition to a different state; and
communicating the key specified by the request with the synchronization destination for the variable corresponding to the key specified by the request and synchronizing the value of the variable corresponding to the key specified by the request in the variable set in the distributed processing device and the value of the variable corresponding to the key specified by the request in the variable set of the synchronization destination when the process of requesting that the variable in the variable set of the distributed processing device be updated is executed.

6. The distributed processing device according to claim 5, wherein
the synchronizing includes:
updating the value of the variable corresponding to the key specified by the request in the variable set when the process of requesting that the variable in the variable set of the distributed processing device be updated is executed;
transmitting a request message requesting that the variable set specified by the synchronization destination be updated to the synchronization destination when the synchronization destination is specified for the variable corresponding to the key specified by the request; and
updating the value of the variable corresponding to the key specified by the request message in the variable set of the distributed processing device specified by the request message and returning, to a synchronization source device, the response message including a result of the referring to when the request message is received from the synchronization source device.

7. The distributed processing device according to claim 5, wherein
the evaluating includes:
sequentially reading contest boxes that are described in a context sheet, which is a file describing a state transition machine by combining the context boxes including condition portions describing conditions or process portions describing processes to be executed;
executing a process including the process of requesting that the variable in the variable set of the distributed processing device be referred to or updated by interpreting the process portion of the read context box; and
evaluating the condition portion of the read context box while referring to the variable in the variable set of the distributed processing device and further evaluating the condition portion in accordance with a result of the evaluation or transitioning to reading of a different context box.

8. The distributed processing device according to claim 5, wherein
the synchronizing includes communicating the key specified by the request with the synchronization destination by unicast.

9. A distributed processing method of performing distributed processing in a sensor network, the distributed processing method comprising:
storing, by a device and as a variable set, a database of a variable that associates a key, a value and a synchronization destination corresponding to the key;
executing, by the device, a process of requesting that the variable in the variable set of the device be referred to or updated in a state and evaluating , by the device, a condition while referring to the variable in the variable set of the device so as to make the state transition to a different state; and
communicating, by the device, the key specified by the request with the synchronization destination for the variable corresponding to the key specified by the request and synchronizing, by the device, the value of the variable corresponding to the key specified by the request in the variable set in the device and the value of the variable corresponding to the key specified by the request in the variable set of the synchronization destination when the process of requesting that the variable in the variable set of the device be updated is executed.

10. The distributed processing method according to claim 9, wherein
the synchronizing includes:
updating, by the device, the value of the variable corresponding to the key specified by the request in the variable set when the process of requesting that the variable in the variable set of the device be updated is executed;
transmitting, by the device, a request message requesting that the variable set specified by the synchronization destination be updated to the synchronization destination when the synchronization destination is specified for the variable corresponding to the key specified by the request; and
updating, by the device, the value of the variable corresponding to the key specified by the request message in the variable set of the device specified by the request message and returning, by the device and to a synchronization source device, the response message including a result of the referring to when the request message is received from the synchronization source device.

11. The distributed processing method according to claim 9, wherein
the evaluating includes:
sequentially reading contest boxes that are described in a context sheet, which is a file describing a state transition machine by combining the context boxes including condition portions describing conditions or process portions describing processes to be executed;
executing a process including the process of requesting that the variable in the variable set of the device be referred to or updated by interpreting the process portion of the read context box; and
evaluating the condition portion of the read context box while referring to the variable in the variable set of the device and further evaluating the condition portion in accordance with a result of the evaluation or transitioning to reading of a different context box.

12. The distributed processing method according to claim 9, wherein
the synchronizing includes communicating the key specified by the request with the synchronization destination by unicast.
